(19) United States
(12) Patent Application Publication
(10) Pub. No.: US 2008/0026899 A1
(43) Pub. Date: Jan. 31, 2008

(54) Drive train for a tractor

(76) Inventors: Robert Carlson, Hudson, WI (US); Bryan Danner, Mayville, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/495,248

(22) Filed: Jul. 28, 2006

(51) Int. Cl. F16H 37/02

(52) U.S. Cl. 475/207

(57) ABSTRACT

A drive train for use with a tractor having an engine includes a transmission module having an input side coupled to the engine and an output side. The output side is rotatable in response to rotation of the input side to define a transmission speed ratio. A differential module includes a drive input coupled to the output side, and including an axle. The axle is configured to rotate in response to rotation of the drive input to define a differential speed ratio. A control module is coupled to the transmission module and to the differential module, and is configured to independently vary the transmission speed ratio and the differential speed ratio. The drive train operates using a single lever control and does not require a clutch.

### BACKGROUND

The present invention relates to a tractor drive train, and in particular to a mechanical continuously variable transmission for a tractor that is controlled by a single control mechanism.

Mechanical transmissions are commonly used commercially in lawn tractors and other small vehicles to effect movement of the drive wheels. Transmissions typically include a number of components, such as a reduction unit, a clutch unit, pulleys, belts, and gears. In commercially available transmissions, these components may vary depending on the application. Other transmissions include hydrostatic transmissions that generally perform better than mechanical transmissions. However, hydrostatic transmissions can be more expensive than mechanical transmissions.

### SUMMARY

In one embodiment, the invention provides a drive train for use with a tractor having an engine. The drive train includes a transmission module having an input side coupled to the engine and an output side. The output side is rotatable in response to rotation of the input side to define a transmission speed ratio. A differential module includes a drive input coupled to the output side, and including an axle. The axle is configured to rotate in response to rotation of the drive input to define a differential speed ratio. A control module is coupled to the transmission module and to the differential module, and is configured to independently vary the transmission speed ratio and the differential speed ratio.

In another embodiment, the invention provides a drive train for use with a tractor. The drive train includes an engine and a transmission module including an input side and an output side. The input side is coupled to the engine such that the input side rotates at a first speed. The output side is operatively connected to the input side and is configured to rotate at a second speed. A differential module includes a differential input and an axle. The differential input is operatively coupled to the output side and is configured to rotate at a third speed in response to rotation of the output side. The axle is configured to rotate at a fourth speed in response to rotation of the differential input. A control module is coupled to the transmission module and the differential module and is configured to vary a first ratio of the first speed to the second speed, and is configured to vary a second ratio of the third speed to the fourth speed.

In yet another embodiment, the invention provides a drive train for use with a tractor having an engine. The drive train includes a transmission module having an input side coupled to the engine, and including an output side. The output side is rotatable in response to rotation of the input side to define a transmission speed ratio. A differential module includes a drive input coupled to the output side, and including an axle. The axle is rotatable in response to rotation of the drive input to define a differential speed ratio and a speed direction. A control module is coupled to the transmission module and the differential module. The control module includes an operator interface configured to move in a first direction to vary the transmission speed ratio, and configured to move in a second direction to vary both the differential speed ratio and the speed direction.

Other aspects of the invention will become apparent by consideration of the detailed description and accompanying drawings.

### BRIEF DESCRIPTION OF THE DRAWINGS

FIG. 1 is a schematic diagram of a riding lawn tractor including a mechanical transmission module and differential according to one embodiment of the invention;

FIG. 2 is a perspective view of the mechanical transmission module and differential shown in FIG. 1;

FIG. 3 is another perspective view of the mechanical transmission module and differential shown in FIG. 1;

FIG. 4 is a perspective section view of the mechanical transmission module of FIG. 1;

FIG. 5 is a perspective view of a fixed portion of a primary pulley of the transmission module of FIG. 4;

FIG. 6 is a perspective view of an upper wedge of the transmission module of FIG. 4;

FIG. 7 is a front view of the upper wedge of FIG. 6;

FIG. 8 is a perspective view of an adjustment collar of the transmission module of FIG. 4;

FIG. 9 is a perspective view of the transmission module, the differential, and a control system of FIG. 1;

FIG. 10 is a perspective bottom view of the transmission module, the differential, and a portion of the control system of FIG. 9;

FIG. 11 is a perspective view of a portion of the control system of FIG. 9;

FIG. 12 is another perspective view of a portion of the control system of FIG. 9;

FIG. 13 is a perspective view of a portion of the differential of FIG. 1;

FIG. 14 is a bottom view of a portion of the differential of FIG. 1;

FIG. 15 is a section view of the differential taken along line 15-15 of FIG. 13 with the control in a first position;

FIG. 16 is a section view of the differential taken along line 16-16 of FIG. 13 with the control in a second position; and

FIG. 17 is a section view of the differential taken along line 17-17 of FIG. 13 with the control in a third position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

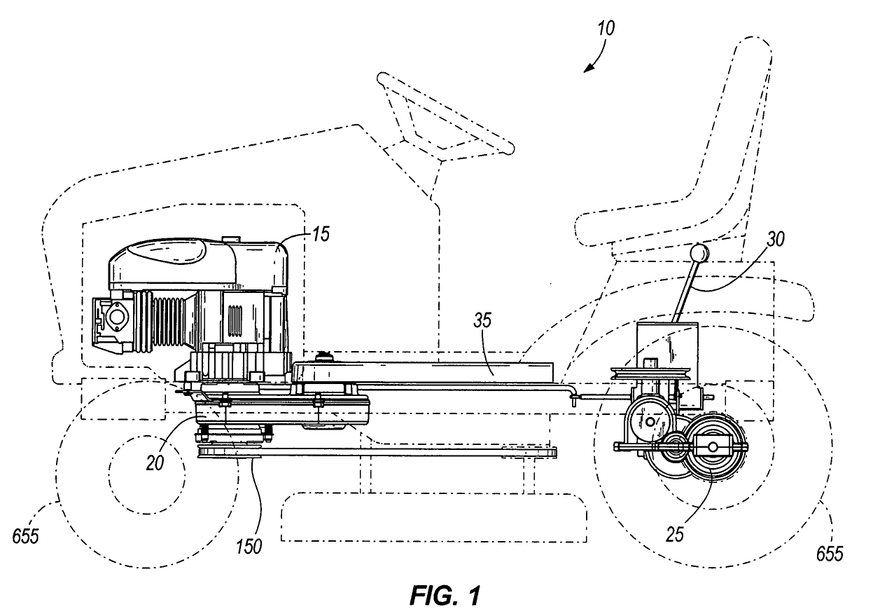

FIG. 1 illustrates a riding lawn tractor 10 including an engine 15, a mechanical transmission module 20, a rear differential 25, and a control system 30 positioned to allow a rider to control the speed and direction of the tractor 10. In the illustrated construction, a vertical shaft internal combustion engine 15 is employed. However, other constructions may employ other types and arrangements of engines. In addition, the illustrated engine 15 is considered a small engine as it includes two or fewer cylinders. The invention described herein is particularly suited for use with small engines 15, but could be used with larger engines if desired.

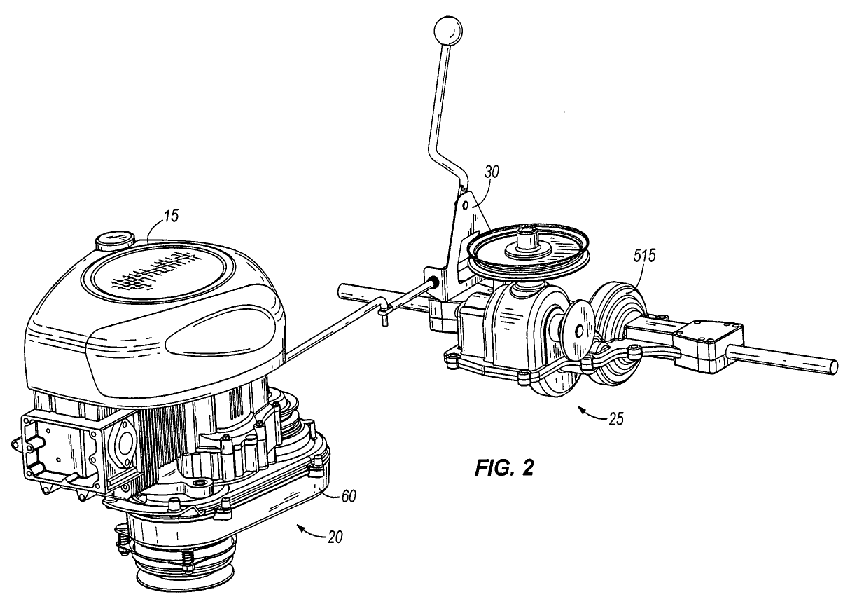

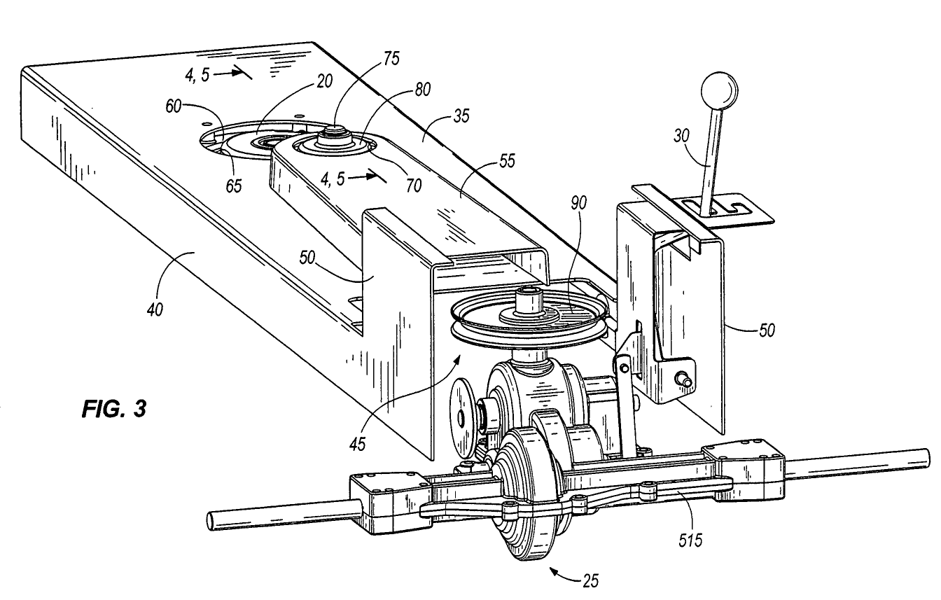

Turning to FIG. 2, the engine 15, transmission 20, differential 25 and a portion of the control system 30 are illustrated apart from the tractor 10 to which they normally attach. A frame member 35 (shown in FIG. 3) extends between the transmission 20 and differential 25 and provides structural support for the transmission 20, the differential 25, the engine 15, and the control system 30. The frame member 35 includes an elongated channel section 40 that defines a partially enclosed space 45 that is oriented downward (i.e., toward the ground). Two extensions 50 extend upward from one end and provide support for the control system 30 as well as other components such as the rider's seat. The differential 25 is disposed adjacent the two extensions 50. The transmission 20 is disposed at least partially within the partially enclosed space 45 near a second end of the frame member. A belt tunnel 55 extends from the transmission 20 toward the first end to provide a partially enclosed space for belt travel as will be discussed with regard to the operation of the transmission 20 and differential 25.

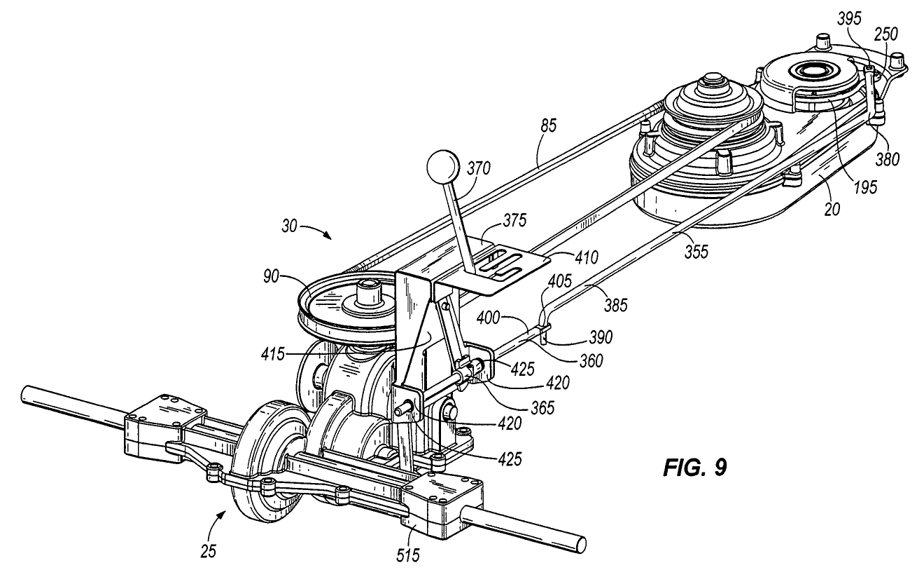

As illustrated in FIG. 3, the transmission 20 includes a housing 60 disposed adjacent a drive-receiving opening 65 that is formed in the frame member 35. A driven shaft opening 70 is formed in a belt cover and is spaced apart from the drive-receiving opening 65. In some constructions, the driven shaft opening 70 is replaced with a bump in the belt cover that provides the necessary clearance. The engine 15 is positioned above the drive-receiving opening 65 to allow the engine drive shaft or another shaft to fit within the drive-receiving opening 65 to couple the transmission 20 to the engine 15. A driven shaft 75 extends from the driven shaft opening 70 and supports a transmission output pulley 80 for rotation. A transfer belt 85 (shown in FIG. 9) extends from the transmission output pulley 80 to a differential input pulley 90 such that rotation of the transmission output pulley 80 produces a corresponding rotation of the differential input pulley 90.

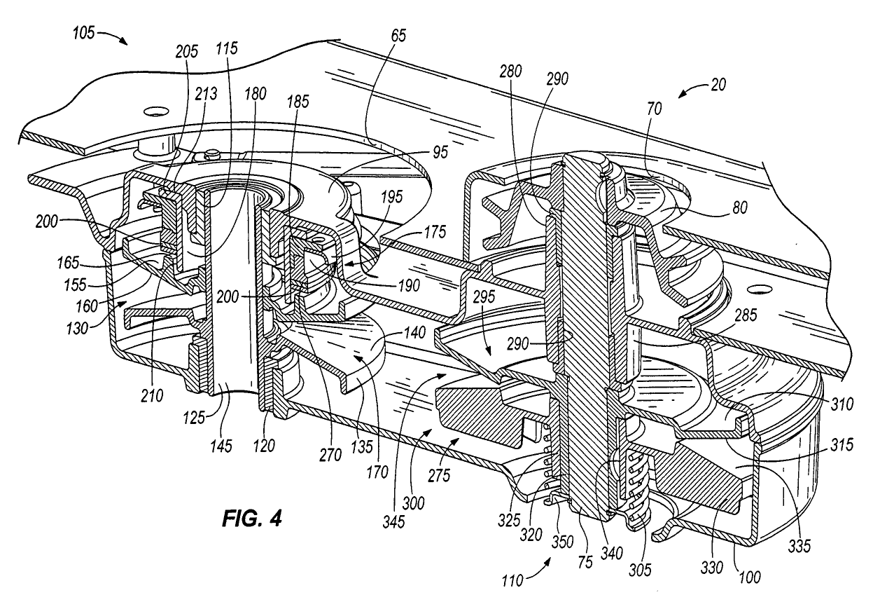

FIG. 4 illustrates the transmission 20 in section to illustrate the internal components. The transmission 20 includes the housing 60 having a first portion 95 and a second portion 100. The housing 60 is arranged to define an input side 105 that is coupled to the engine 15 and thus receives input power in the form of torque at a speed, and an output side 110 that delivers power from the transmission 20 to the differential 25.

The drive-receiving opening 65 is part of the input side 105 of the transmission 20. A first bushing 115 is positioned within the first portion 95 of the housing 60, and a second bushing 120 is positioned in the second portion 100 of the housing 60. The first bushing 115 and second bushing 120 cooperate to support a fixed portion 125 of a primary pulley 130.

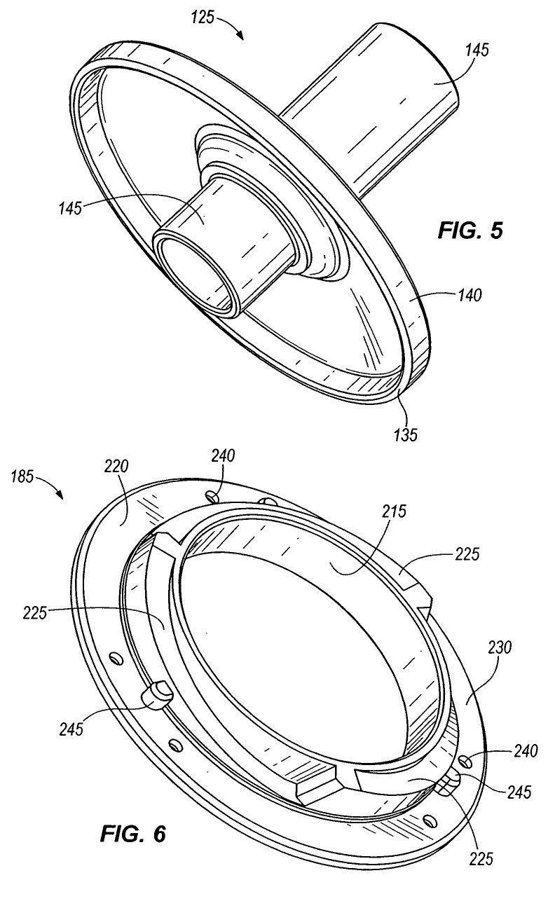

The fixed portion 125, shown in FIG. 5, includes a pulley portion 135 that defines a frustoconical surface 140, and a shaft portion 145. In the illustrated construction, the shaft portion 145 is hollow to allow for the passage of the drive shaft from the engine 15. The drive shaft passes through the shaft portion 145 to allow for the connection of a secondary drive member 150 (shown in FIG. 1) that in turn drives the mower blades or other auxiliary equipment. In addition, the shaft portion 145 is coupled to the drive shaft such that the fixed portion 125 rotates with the drive shaft. In preferred constructions, the fixed portion 125 includes a steel shaft portion 135 and an integrally-cast aluminum pulley portion 135.

Returning to FIG. 4, the primary pulley 130 includes a movable portion 155 that moves along the axis of rotation of the fixed portion 125. The movable portion 155 includes a frustoconical surface 160 and an adjustment boss 165. The fixed portion 125 and movable portion 155 are positioned such that the respective frustoconical surfaces 140, 160 cooperate to define a V-shaped channel 170 that receives a primary belt. Movement of the movable portion 155 with respect to the fixed portion 125 varies the size of the V-shaped channel 170 as will be discussed below.

In some constructions, a biasing member (not shown) is positioned to bias the movable portion 155 away from the fixed portion 125. For example, one construction employs a coil spring between the fixed portion 125 and the movable portion 155 that biases the movable portion 155 away from the fixed portion 125.

With continued reference to FIG. 4, the transmission 20 includes an adjustment mechanism 175 that is positioned to move the movable portion 155 of the primary pulley 130. The adjustment mechanism 175 includes a bushing 180, an upper wedge 185, a lower wedge 190, an adjusting collar 195, and one or more axial spacers 200. The bushing 180 includes a flange 205, a cylindrical guide surface 210 and an engagement surface 213 that engages the first portion 95 of the housing 60 to fix the position of the bushing 180. The flange 205 abuts the first portion 95 of the housing 60 to inhibit axial movement of the bushing 180 toward the first portion 95 of the housing 60.

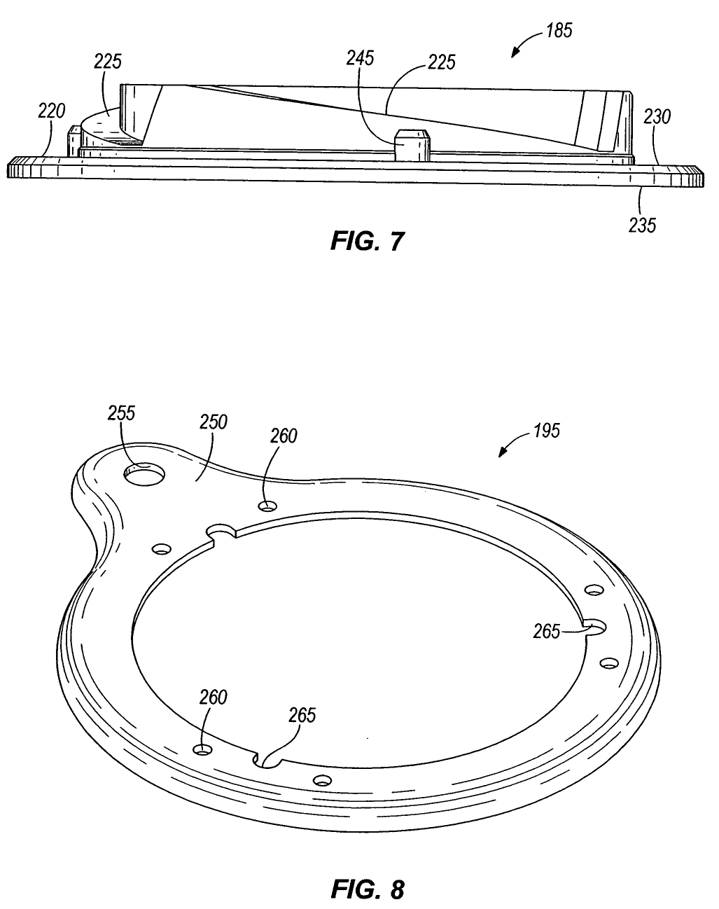

As shown in FIGS. 6 and 7, the upper wedge 185 includes a central aperture 215, a flange 220, and a plurality of ramp portions 225. The central aperture 215 is sized to closely engage the cylindrical guide surface 210 to allow substantially free rotation of the upper wedge 185 around the bushing 180. The ramp portions 225 extend around the aperture 215 and define a varying axial thickness along the ramp 225. In the illustrated construction, three ramps 225 are employed. However, other constructions may employ fewer than three ramps 225 or more than three ramps 225 if desired.

The flange 220 includes a first surface 230 that surrounds the ramps 225, and a second surface 235 opposite the ramps 225. The second surface 235 abuts the bushing flange 205 to inhibit movement of the upper wedge 185 toward the first portion 95 of the housing 60. Several apertures 240 extend through the flange 220 and several alignment tabs 245 extend from the flange 220.

The adjusting collar 195, shown in FIG. 8, includes a tab 250, a connecting aperture 255 passing through the tab 250, apertures 260 that align with the apertures 240 in the flange 220, and alignment slots 265 that receive the alignment tabs 245. Fasteners, pins, or other devices extend through the apertures 240, 255 in the adjusting collar 195 and the flange 220 to fixedly attach the collar 195 to the upper wedge 185.

The lower wedge 190 includes a central aperture, a plurality of ramp portions, and a lower surface 270 opposite the ramp portions. The central aperture is sized to closely fit over the bushing 180 to allow free rotation of the lower wedge 190 with respect to the bushing 180. The ramp portions correspond with and engage the ramp portions 225 of the upper wedge 185 such that rotation of the upper wedge 185 with respect to the lower wedge 190 causes the ramp portions to slide on one another and changes the axial distance between the second surface 235 and the lower surface 270. In some constructions, anti-friction material is applied to the ramp portions 225 to reduce the sliding friction between the lower wedge 190 and the upper wedge 185.

The lower surface 270 is coupled to the adjustment boss 165 such that axial movement of the second surface 235 produces a corresponding axial movement of the adjustment boss 165 and the movable portion 155. Because the axial position of the second surface 235 is substantially fixed, rotation of the upper wedge 185 with respect to the lower wedge 190 produces axial movement of the lower surface 270 in an axial direction. As illustrated in FIGS. 4 and 5, spacers 200 may be positioned between the adjustment boss 165 and the lower surface 270 as may be required.

The output side 110 of the transmission 20 includes the driven shaft 75, the output pulley 80, and a secondary pulley 275. The first portion 95 of the housing 60 includes a first boss 280 that extends from the housing 60 along the driven shaft axis, and includes a second boss 285 that extends in the opposite direction. The first boss 280 and the second boss 285 cooperate to define an opening. Bushings 290 fit within the first boss 280 and the second boss 285 to support the driven shaft 75 for rotation.

The secondary pulley 275 includes a secondary fixed portion 295, a secondary movable portion 300, and a biasing element 305. The secondary fixed portion 295 includes a pulley portion 310 that defines a frustoconical surface 315, and includes a shaft portion 320 that supports the pulley portion 310 and abuts one of the bushings 290 to inhibit axial movement of the secondary fixed portion 295. In preferred constructions, the secondary fixed portion 295 includes a steel shaft portion 320 and an integrally-cast aluminum pulley portion 310.

The secondary movable portion 300 includes a collar portion 325, and includes a pulley portion 330 that defines a frustoconical surface 335. The collar portion 325 supports the pulley portion 310 and defines a cylindrical aperture 340 that fits over the shaft portion 320 to allow axial movement of the secondary movable portion 300 with respect to the secondary fixed portion 295. The frustoconical surface 315 of the secondary fixed portion 295 cooperates with the frustoconical portion 335 of the secondary movable portion 300 to define a second V-shaped slot 345. Movement of the secondary movable portion 300 produces a corresponding variation in the width of the second V-shaped slot 345. Anti-friction material or a sleeve-type bushing may be located between the cylindrical aperture 340 and the shaft portion 320 of the fixed portion 295.

A locking cap 350 engages the driven shaft 75 and sandwiches the shaft portion 320 of the secondary fixed portion 295 between the locking cap 350 and the bushing 290 to inhibit movement of the secondary fixed portion 295 with respect to the driven shaft 75. The biasing member 305 engages the locking cap 350 at one end and the secondary movable portion 300 at the other to bias the secondary movable portion 300 toward the secondary fixed portion 295.

Operation of the transmission 20 will now be described with continued reference to FIG. 4. In preferred constructions, the engine 15 combusts fuel to produce rotation of the crankshaft. Generally, a governor or other speed controller maintains the speed of the engine at or near a predetermined speed.

The crankshaft is coupled to the shaft portion 145 of the fixed portion 125 of the primary pulley 130 such that the fixed portion 125 of the pulley 130 rotates with the crankshaft. As discussed, the crankshaft or another shaft may extend below the transmission to drive a pulley 150 that drives other components such as one or more mower blades. Alternatively, the crankshaft or another shaft could directly drive the other components or mower blades.

The movable portion 155 of the primary pulley 130 is coupled to the shaft portion 145 of the fixed portion 125 such that the movable portion 155 is substantially free to move axially along the axis of rotation, but is not free to rotate relative to the fixed portion 125. As such, the fixed portion 125 and the movable portion 155 rotate in unison. In one construction, one or more axial-extending grooves, formed in one of the fixed portion 125 and the movable portion 155, engages one or more corresponding guides formed in the other of the fixed portion 125 and the movable portion 155. In still other constructions, a spline is formed in the shaft portion 145, and the movable portion 155 includes a spline-receiving aperture that allows for axial movement and facilitates the transfer of torque between the fixed portion 125 and the movable portion 155. In some constructions, anti-friction material or a bushing may be positioned between the movable pulley portion 155 and the fixed shaft portion 125.

The V-shaped slot 170 defined by the fixed portion 125 and the movable portion 155 receives the primary belt. The primary belt is V-shaped such that it engages the two frustoconical surfaces 140, 160 of the fixed portion 125 and the movable portion 155. When the movable portion 155 is in a first position, the space between the fixed portion 125 and the movable portion 155 is such that the primary belt engages the primary pulley 130 near the axis of rotation. When the movable portion 155 is in a second position, the space between the fixed portion 125 and the movable portion 155 is such that the primary belt is forced outward and engages the frustoconical surfaces 140, 160 at a second position further from the axis of rotation.

The biasing member (if employed) biases the movable portion 155 away from the fixed portion 125, toward the first position and maintains contact between the adjustment boss 165 and the spacer 200. The upper wedge 185 and the lower wedge 190 are arranged such that their ramp surfaces engage one another and they are positioned between the spacer or spacers 200 and the bushing 180. The adjustment collar 195 attaches to the upper wedge 185 such that rotation of the adjustment collar 195 produces a corresponding rotation of the upper wedge 185. As the upper wedge 185 rotates in a first direction, the ramp surfaces 225 of the upper wedge 185 move with respect to the ramp surfaces of the lower wedge 190 to move the lower wedge 190 toward the pulley 130. Downward movement of the lower wedge 190 produces a corresponding movement of the movable portion 155 toward the fixed portion 125. When the upper wedge 185 rotates in the opposite direction, the biasing member biases the lower wedge 190 upward to maintain contact between the ramp surfaces. Thus, the movable portion 155 moves away from the fixed portion 125.

When the adjustment collar 195 is in the first position, the movable portion 155 is spaced from the fixed portion 125 such that the primary belt rotates near the axis of rotation. In this position, the belt rotates at a first speed. As the adjustment collar 195 rotates in the first direction, the movable portion 155 moves toward the fixed portion 125 to force the primary belt outward. At its most outward position, the primary belt rotates at a second speed that is higher than the second speed.

The primary belt also engages the secondary pulley 275 such that the secondary pulley 275 rotates in response to the rotation of the primary pulley 130. The secondary pulley 275 includes frustoconical surfaces 315, 335 similar to those of the primary pulley 130 that engage the primary belt such that the secondary pulley 275 rotates in response to rotation of the primary pulley 130. The secondary pulley 275 includes a secondary movable portion 300 that moves with respect to the secondary fixed portion 295. The secondary movable portion 300 moves to maintain the tension of the primary belt. For example, when the adjustment collar 195 is in the first position, the primary belt is positioned near the axis of rotation of the primary pulley 130. To maintain the desired tension in the belt, it is desirable that the primary belt be spaced away from the axis of rotation of the secondary pulley 275. As the adjustment collar 195 rotates in the first direction, the primary belt moves outward, away from the axis of rotation of the primary pulley 130. As the belt moves outward, the belt tension increases. The increased tension produces a separating force that acts on the secondary movable portion 300 in opposition to the biasing member 305 and moves the secondary movable portion 300 away from the secondary fixed portion 295 to allow the belt to move closer to the axis of rotation of the secondary pulley 275. In this way the overall length of the belt as well as the belt tension remain constant without the use of an idler pulley or other belt tensioner.

For a fixed engine speed, the primary pulley 130 rotates at the same fixed speed. However, the linear speed of the primary belt varies with its distance from the axis of rotation. Thus, if the diameter at which the primary belt engages the primary pulley 130 is doubled, the linear distance the primary belt must travel for a given rotation of the primary pulley 130 must double. This results in a doubling of the belt speed. Thus, by moving the primary belt outward, the transmission is able to move the primary belt at a faster linear speed which results in a higher rotational speed of the secondary pulley 275.

Furthermore, the described arrangement allows for a greater variation in the rotational speed of the secondary pulley 275 with respect to the primary pulley 130. For example, for a fixed engine speed the primary pulley 130 rotates at the same fixed speed. However, the linear speed of the primary belt varies with its distance from the axis of rotation. Thus, if the diameter at which the primary belt engages the primary pulley 130 is doubled, the linear distance the primary belt must travel for a given rotation of the primary pulley must double. This results in a doubling of the belt speed.

The secondary pulley 275 is coupled to the output pulley 80 such that the output pulley 80 rotates at the same speed as the secondary pulley 275. The transfer belt 85 extends from the output pulley 80 to the differential pulley 90 to provide an input to the differential 25.

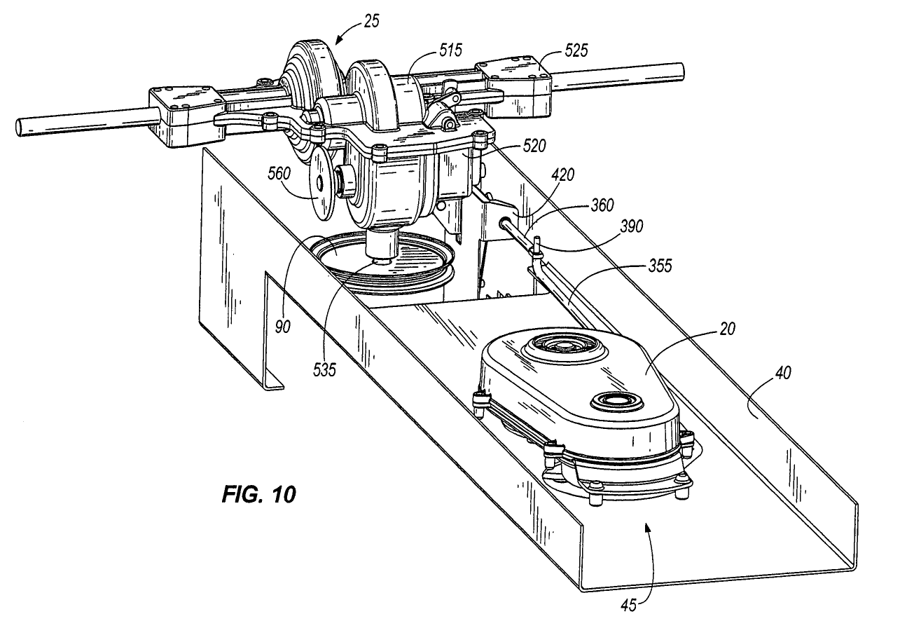

The control system 30 illustrated in FIGS. 9-17 allows a rider seated on the tractor 10 to control the speed and the direction of the tractor 10 without a clutch mechanism. In the illustrated construction, the control system 30 controls the output speed of the transmission 20 and also controls the gearing within the differential 25. The illustrated differential 25 includes two forward speed ranges, or forward speed ratios, and a single reverse speed range, or reverse speed ratio, with other differential arrangements also being possible.

As illustrated in FIG. 9, the control system 30 includes a link arm 355, a control rod 360, a control collar 365, an operator link 370, and a control bracket 375. The link arm 355 includes a first end 380 that engages the adjustment collar 195 and a second end 385 that includes a hook portion 390 that engages the control rod 360. In the illustrated construction, a threaded fastener 395 is employed to attach the first end 380 to the tab 250 of the adjustment collar 195.

The control rod 360 is a substantially elongated cylindrical rod that includes a first end 400 that defines an aperture 405. The hook portion 390 fits within the aperture 405 such that linear movement of the rod 360 along its long axis is transferred to the link arm 355, while the control rod 360 remains substantially free to rotate slightly with respect to the link arm 355.

The control bracket 375 includes an interface surface 410, a side surface 415, and two support ears 420 that extend from the side surface 415. Each support ear 420 includes an aperture 425 through which the control rod 360 passes. The apertures 425 may include bearings (e.g., bushings, journal bearings, linear bearings, roller bearings, etc.) that support the control rod 360 for both rotation and axial movement.

The interface surface 410 extends from the side surface 415 and is spaced apart from the support ears 420. The interface surface 410 defines an interface aperture 430 that includes three substantially parallel paths 435a, 435b, 435c and one transverse path 440.

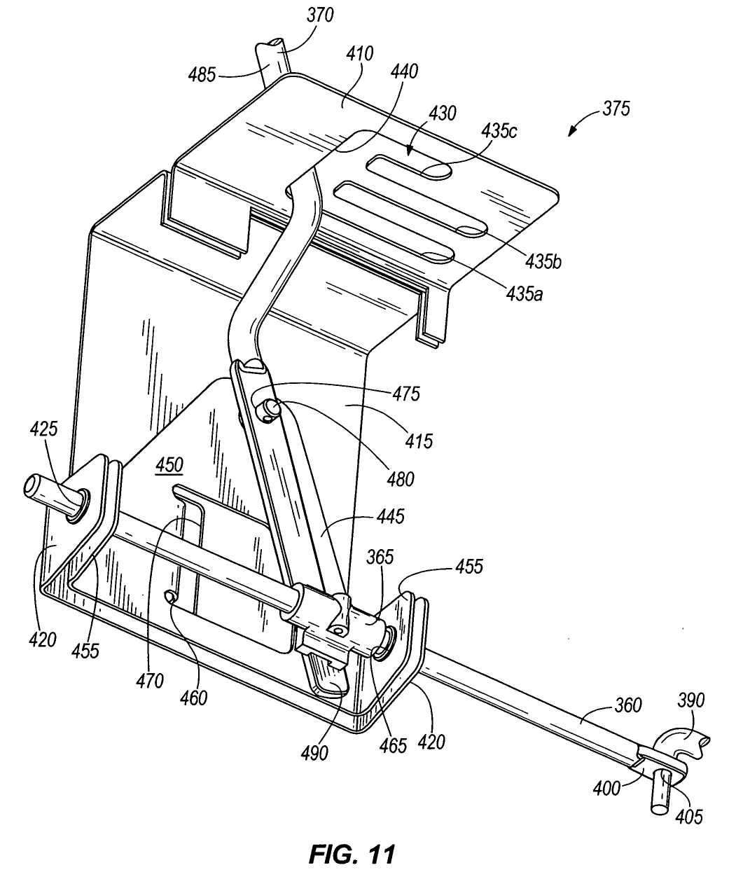

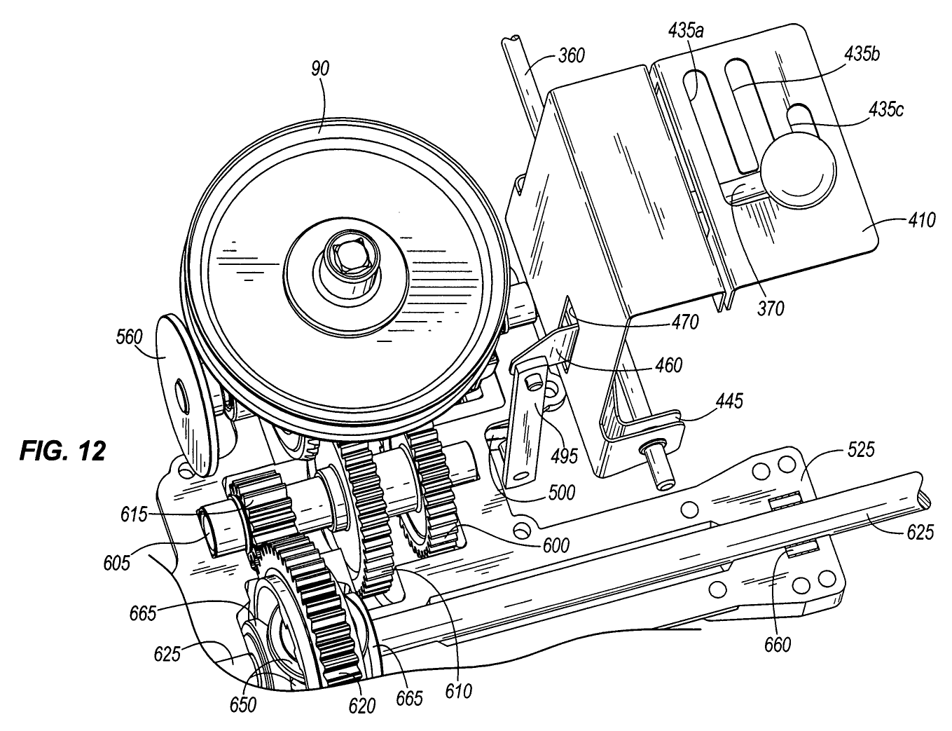

As illustrated in FIG. 11, the control collar 365 facilitates the connection of the operator link 370 to the control rod 360. The control collar 365 fixedly attaches to the control rod 360 such that movement of the control collar 365 in an axial direction (i.e., along the axis of the control rod 360) produces a corresponding axial movement of the control rod 360 and the link arm 355. In addition, rotational movement of the control collar 365 about the axis of the control rod 360 produces a corresponding rotation of the control rod 360. In other constructions, the control collar 365 is free to rotate about the control rod 360 but is axially fixed to the control rod 360.

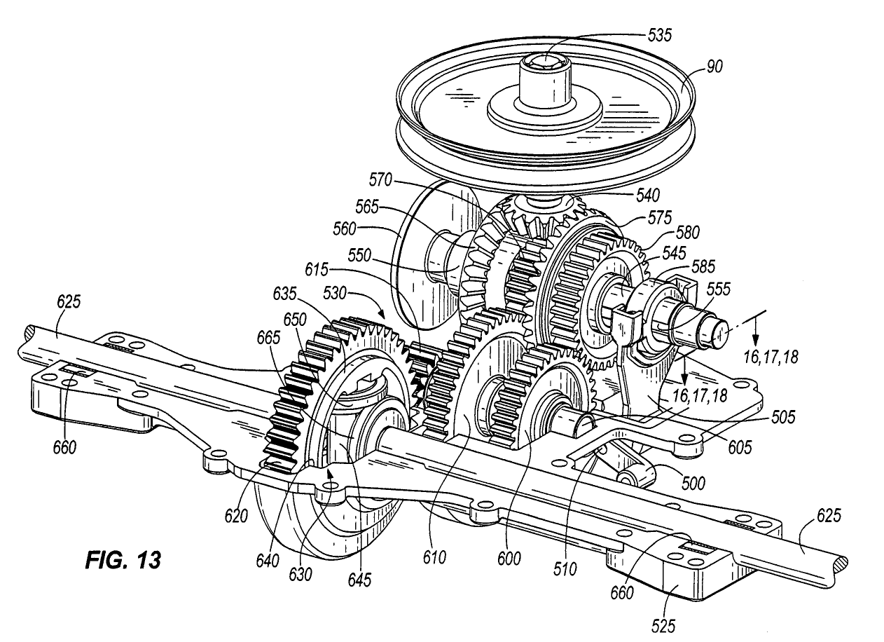

The control system 30 also includes a transfer link 445 that includes a first portion 450, a pair of ears 455 extending from the first portion 450, and a tab 460 extending from the first portion 450 in a direction substantially opposite the ears 455. The ears 455 define apertures 465 that receive the control rod 360 such that the transfer link 445 is supported for pivotal movement about the control rod 360. The tab 460 extends through an aperture 470 formed in the sidewall 415 of the control bracket 375 as illustrated in FIG. 13.

The operator link 370 defines an aperture 475 that facilitates the attachment of the operator link 370 to the transfer link 445. A pin 480 or other attachment member extends through the aperture 475 to pivotally attach the operator link 370 to the transfer link 445, while inhibiting relative non-pivotal movement between the operator link 370 and the transfer link 445. The operator link 370 also includes a first end 485 disposed above the interface surface 410 in a position that allows the user of the lawn tractor 10 to manipulate the operator link 370, and a second end 490 coupled to the control collar 365. Thus, movement of the operator link 370 in a first direction substantially parallel to the control rod 360 produces a corresponding movement of the control collar 365 and control rod 360 in an opposite direction. However, movement of the operator link 370 in a direction transverse to the control rod 360 produces a pivoting movement of the transfer link 445 about the control rod 360. The pivoting motion produces a similar arcuate motion of the tab 460.

With reference to FIGS. 12 and 13, the control system 30 also includes a crank link 495, a crank arm 500, and an adjusting fork 505. The crank link 495 connects to the tab 460 at one end and the crank arm 500 at the opposite end. A shaft 510 interconnects the crank arm 500 and a first end of the fork 505 such that pivotal movement of the tab 460 is converted to rotary movement of the shaft 510. The rotary movement of the shaft 510 produces a pivotal movement of the second end of the fork 505. The second end of the fork 505 is movable between a first or high-speed position and a second or reverse position. In addition, the illustrated construction includes a third or low-speed position between the first position and the second position. The arrangement and the operation of the differential 25 will be discussed below with regard to FIGS. 13-17.

In operation, the control system 30 is operable to both vary the output speed of the transmission 20 and to shift the differential 25 between the first speed range, the second speed range, and the third speed range. With reference to FIGS. 11 and 12, the operator link 370 extends through the aperture 430 in the interface surface such that the motion of the operator link 370 is constrained by the shape of the aperture 430. When the operator link 370 is moved in the transverse direction 440, the operator link 370 pivots the transfer link 445 about the control rod 360 to pivot the tab 460, move the crank link 495, rotate the crank arm 500 and pivot the fork 505. The pivot motion of the fork 505 shifts the differential 25 between the first speed range, the second speed range and the third speed range. Motion of the operator link 370 in the direction parallel to the control rod 360 produces a corresponding but opposite movement of the control rod 360 along the control rod axis. The movement of the control rod 360 produces a similar movement of the link arm 355, which in turn rotates the adjustment collar 190. As discussed with regard to the transmission 20, rotation of the adjustment collar 190 produces a corresponding change in the output speed of the transmission 20, which changes the input speed to the differential 25 and the speed of the tractor 10.

It should be noted that the angular travel of the adjusting collar 195 and the axial travel of the upper and lower wedges 185, 190 is sufficient to disengage the primary belt from the primary pulley 130. Thus, when the operator link 370 is near or in the transverse path 440, the transmission 20 is in a neutral mode as there is no belt tension. This allows for the easy shifting of the gears within the differential 25 without the need for a clutch.

In the construction illustrated in FIGS. 9, 11, and 12, with the operator link 370 positioned adjacent the innermost end of the transverse path 440 the transmission is set in the first speed range or high-speed range forward gear. Movement of the operator link 370 along the first parallel path 435a increases the output speed of the transmission 20, while maintaining the transmission 20 in the first speed range or high-speed range. To shift to the third speed range or low speed range, the operator moves the operator link 370 along the transverse path 440 until it is aligned with the second parallel path 435b. Movement of the operator link 370 along the second parallel path 435b will cause an increase in the transmission output speed, but will maintain the differential 25 in the third speed range or low speed range. To shift the lawn tractor 10 into a reverse direction, the operator simply moves the operator link 370 to the outer most parallel groove 435c. Movement along the third parallel path 435c will increase the output speed of the transmission 20, while maintaining the differential 25 in the reverse gear. In the illustrated constructions the third parallel path 435c is shorter than the first and second paths 435a, 435b to limit the output speed of the transmission 20 in reverse.

FIGS. 13-17 illustrate the differential 25. The differential 25 includes a housing 515 that generally includes a first portion 520 and a second portion 525 that attach to one another to define an interior space 530. Gears, bearings, and other mechanical components are disposed within the interior space 530. In addition, a lubricant such as oil is contained within the interior space 530 to lubricate and cool the moving components.

As shown in FIG. 13, the input pulley 90 is disposed outside of the housing 515 and is supported for rotation by an input shaft 535. An input bevel gear 540 is coupled to the input shaft 535 such that the bevel gear 540 rotates at the same speed as the input pulley 90.

A first support shaft 545 is supported by the housing 515 for rotation and extends out one side of the housing 515 to define an exposed portion 550. The shaft 545 includes two slots 555 that extend along the length of the shaft 545 for at least a portion of the length. In preferred constructions, bearings are disposed at either end of the shaft 545 to support the shaft 545 for smooth rotation. A brake disk 560 is attached to the exposed portion 550 and can be used to slow or stop movement of the lawn tractor 10 as is known in the art.

Four gears are supported by the shaft 545 and are free to rotate about the shaft 545 but are fixed axially to inhibit movement of the gears along the length of the shaft 545. A first or reverse bevel gear 565 is disposed near the exposed portion 550 of the shaft 545. A second or low-speed range spur gear 570 is positioned adjacent the reverse bevel gear 565 on the side opposite the exposed portion 550 of the shaft 545. A third or forward bevel gear 575 is disposed adjacent the low-speed range spur gear 570, and a fourth or high-speed range spur gear 580 is positioned adjacent the forward bevel gear 575 and near the second end of the shaft 545 away from the exposed portion 550. Each of these gears 565, 570, 575, 580 is free to rotate about the shaft 545. Thus, the input bevel gear 540 engages both the forward bevel gear 575 and the reverse bevel gear 565 such that the forward bevel gear 575 rotates about the shaft 545 in a first direction, while the reverse bevel gear 565 rotates about the shaft 545 in a second direction opposite the first direction.

A shift collar 585 is positioned on the shaft 545 and is coupled to the fork 505 such that movement of the fork 505 produces a corresponding axial movement of the collar 585 along the shaft 545. Two shift keys 590 are positioned within the shaft slots 555 such that a first end of each shift key 590 is fixedly coupled to the collar 585. The second ends of the shift keys 590 include a gear engaging boss 595 that, when properly positioned, couples one or more of the gears 565, 570, 575, 580 to the shaft 545 for rotation.

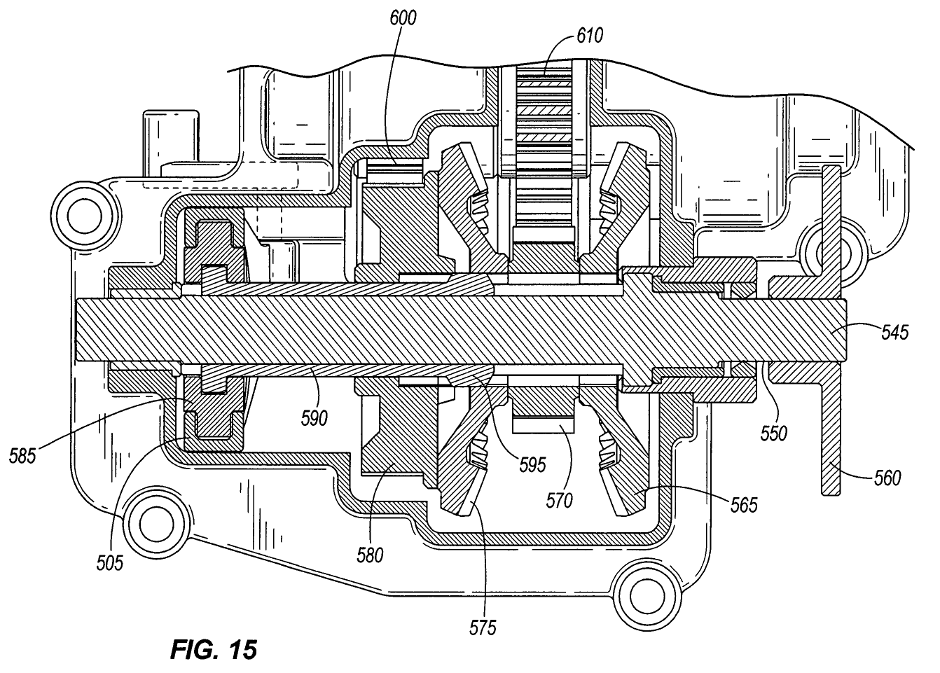

FIG. 15 illustrates the position of the fork 505, collar 585, and shift keys 590, when the control system 30 is in the first or high-speed forward position (slot 435a). In this position, the fork 505 moves the collar 585 to an outermost position that is furthest from the gears 565, 570, 575, 580. In this position, the shift keys 590 are positioned such that the gear-engaging bosses 595 engage the forward bevel gear 575 and the second or high-speed range spur gear 580 such that the forward bevel gear 575 and the high-speed range spur gear 580 rotate in unison with the shaft 545.

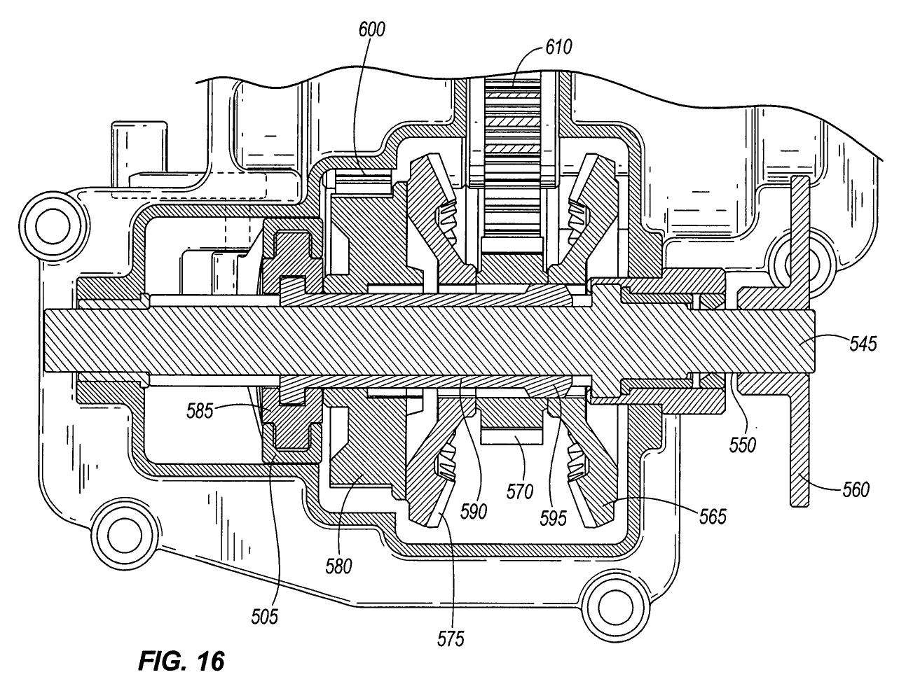

In FIG. 16, the control system 30 has been moved to the second or reverse position (slot 435c). Here, the fork 505 has moved the shift keys 590 to an innermost position adjacent the high-speed range spur gear 580. In this position the shift keys 590 extend to a point that allows the gear-engaging portions 595 to engage the reverse bevel gear 565 and the first or low speed range spur gear 570 such that the reverse bevel gear 565 and the low speed range spur gear 570 rotate in unison with the shaft 545.

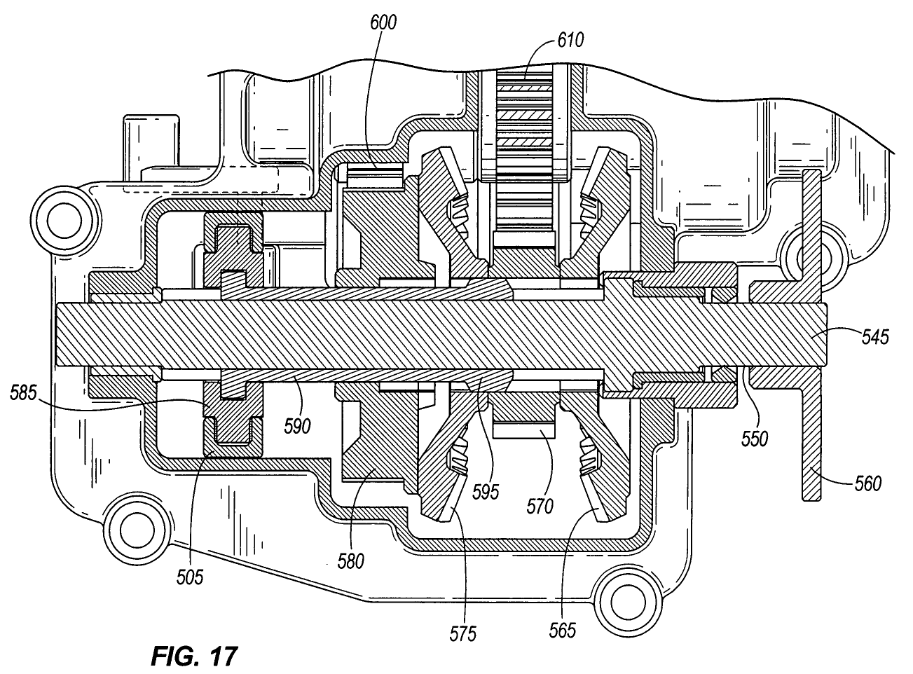

In an intermediate or third position (slot 435b), illustrated in FIG. 17, the fork 505 has moved the collar 585 to a position between the innermost and outermost positions. In this position, the shift keys 590 are shifted such that the gear-engaging bosses 595 engage the forward bevel gear 575 and the second or high-speed range spur gear 580 such that the forward bevel gear 575 and the high-speed range spur gear 580 rotate in unison with the shaft 545. Thus, the present arrangement allows for shifting between low-speed forward, high-speed forward, and reverse without a clutch using a single control lever 370. The single control lever 370 also controls the output speed of the transmission 20 and thus the speed of the tractor 10.

As illustrated in FIG. 13, the forward bevel gear 575 and the reverse bevel gear 565 are approximately the same size and are somewhat larger than the input bevel gear 540. Thus, a first speed reduction is achieved between the input bevel gear 540 and the forward or reverse bevel gear 575, 565.

When the control system 30 is in the first position (FIG. 15), the forward bevel gear 575 and the second spur gear 580 are coupled to the shaft 545 such that the shaft 545 rotates in a forward direction. The remaining gears 565, 570 on the shaft 545 freely rotate with the gears to which they mesh. The second spur gear 580 engages a third spur gear 600 that is supported for rotation on a second shaft 605. The second shaft 605 is disposed parallel to the first shaft 545 and supports not only the third spur gear 600 but also supports a fourth spur gear 610 and a fifth spur gear 615. As with the first shaft 545, the second shaft 605 is preferably supported by bearings to reduce the friction between the shaft 605 and the housing 515 and assure smooth rotation of the shaft 605.

The third spur gear 600 is fixedly attached to the second shaft 605 and is similar in size to the second spur gear 580. As such, there is little or no speed reduction between the first shaft 545 and the second shaft 605 and the second shaft 605 rotates in a forward direction when the control system 30 is in the first position.

When the control system is in the second position (FIG. 16), the reverse bevel gear 565 and the first spur gear 570 are coupled to the shaft 545 such that the shaft 545 rotates in a reverse direction. The remaining gears 575, 580 on the shaft 545 freely rotate with the gears with which they mesh. The first spur gear 570 engages the fourth spur gear 610 that is supported for rotation on the second shaft 605.

The fourth spur gear 610 is larger than the first spur gear 570, thus producing a second stage of speed reduction. Thus, when the control system 30 is in the second position, the second shaft 605 rotates at a speed that is slower than the first shaft 545 and rotates in a reverse direction.

When the control system 30 is in the third position (FIG. 17), the forward bevel gear 575 and the first spur gear 570 are coupled to the shaft 545 such that the shaft 545 rotates in a forward direction. The remaining gears 565, 580 on the shaft 545 freely rotate with the gears with which they mesh. The first spur gear 570 engages the fourth spur 610 gear that is supported for rotation on the second shaft 605. As with the second position, when in the third position, the second shaft 605 rotates at a speed that is slower than the first shaft 545 but rotates in a forward direction.

When the third spur gear 600 is being driven by the second spur gear 580, the fourth spur gear 610 must rotate with the second shaft 605 as they are fixedly attached to one another. However, since the first spur gear 570 is not engaged, it is free to rotate about the first shaft 545 at any speed. Similarly, when the fourth spur gear 610 is driven by the first spur gear 570, the third spur gear 600 must rotate with the second shaft 605. However, the ability of the second spur gear 580 to freely rotate about the first shaft 545 inhibits binding of the transmission 20.

The fifth spur gear 615, positioned near one end of the second shaft 605, engages a ring gear 620 that is supported substantially coaxially with a pair of axles 625. No matter which gear 600, 610 causes the rotation of the second shaft 605, the rotation rotates the fifth spur gear 615, which rotates the ring gear 620. As illustrated, the ring gear 620 is larger than the fifth gear 615, thereby producing a third stage of speed reduction (second stage if the control system 30 is in the first position). The ring gear 620 includes spur gear teeth on an outer surface of a ring that defines a substantially hollow ring interior 630.

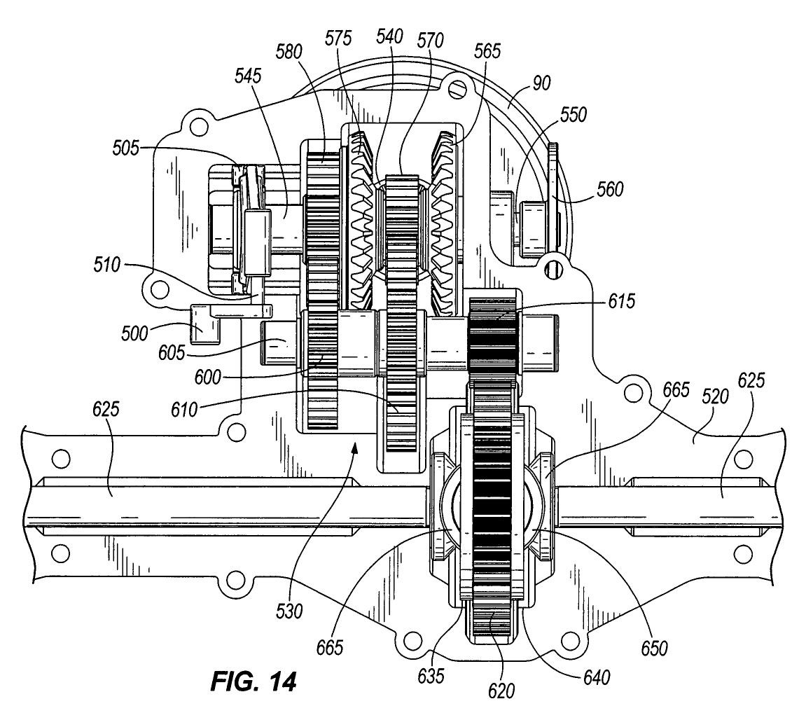

In some constructions, the ring gear 620 includes a shoulder 635 (FIG. 14) that engages a corresponding shoulder 640 formed as part of the housing 515. The engaged shoulders 635, 640 act as a bearing (i.e., a journal bearing) that supports the ring gear 620 for rotation about a ring gear axis. In other constructions other support systems are employed to support the ring gear 620 as will be discussed below.

Two axles or shafts 645 extend toward one another along the axis of the ring gear 620 within the ring interior 630 and support two ring bevel gears 650 for rotation. Each of the ring bevel gears 650 is rotatably attached to one of the shafts 645 such that the ring bevel gears 650 are free to rotate about or with their respective shafts 645. In most constructions, bearings support the bevel gears 650 on the shafts 645 within the ring gear 620 to facilitate smooth reduced friction rotation.

The two axles 625 extend from the housing 515 and support wheels 655 (shown in FIG. 1) that in turn support the vehicle 10. The axles 625 extend along the ring gear axis and are substantially parallel to the first shaft 545 and the second shaft 605. An outer bearing 660, positioned between the housing 515 and the respective axle 625 near the point where the axle exits the housing 515, at least partially supports each axle 625 for rotation. Inner bearings (not shown) may be employed to further support each axle 625 in constructions that do not employ a shoulder 635 on the ring gear 620. In these constructions, the inner bearings are positioned between the housing 515 and the axle 620 near the inner chamber 530.

Each axle 625 supports an axle bevel gear 665 disposed at the inner most end and engaged with the ring bevel gears 650. In the illustrated construction, the axle bevel gears 665 are substantially the same size as the ring bevel gears 650. Of course other sizes and gear types are possible.

The ring bevel gears 650 rotate with the ring gear 620, but do not rotate about the ring gear shafts 645 during straight travel of the vehicle 10. Rotation of the ring bevel gears 650 with the ring gear 620 causes rotation of the axle bevel gears 665 and rotation of the vehicle wheels 655. During a turn, the inner wheel rotates more slowly than the outer wheel. To facilitate this, the ring bevel gears 650 rotate about (or with) the ring shafts 645, thereby allowing the axle bevel gear 665 associated with the inner wheel to rotate slower than the axle bevel gear 665 associated with the outer wheel.

The differential 25 has been described as including several bearings. While not specified, journal, needle, roller, ball, tapered roller bearings, and the like could be used for any or all of the bearings described.

In operation, the transmission 20 provides power to the input pulley 90 in the form of a torque at a speed. The input pulley 90 operates at a first speed that varies in response to the position of the control system 30. The input bevel gear 540 rotates with the input pulley 90 at the same speed as the input pulley 90.

The input bevel gear 540 engages both the forward bevel gear 575 and the reverse bevel gear 565 to rotate the first shaft 545 at a second speed that is slower than the first speed. The position of the control system 30 determines which of the forward bevel gear 575 and reverse bevel gear 565 is rotationally coupled to the shaft 545. Thus, the control system 30 determines the direction of rotation of the shaft 545. In the illustrated construction, the forward and reverse bevel gears 575, 565 are approximately 2.5 times the diameter of the input bevel gear 540. As such, the first shaft 545 rotates about 2.5 times slower than the input pulley 90. The direction of rotation depends on which of the forward bevel gear 575 and the reverse bevel gear 565 is engaged with the shaft 545.

When the control system 30 is in either the second position or the third position, the first spur gear 570 is engaged with the first shaft 545 and thus drives the second shaft 605 via the fourth spur gear 610. In the illustrated construction, the fourth spur gear 610 is approximately 2.5 times larger than the first spur gear 570, thereby producing a second stage of speed reduction. As such, the second shaft 605 rotates at a third speed that is about 2.5 times slower than the second speed when the control system 30 is in either the second position or the third position.

When the control system 30 is in the first position, the second spur gear 580 drives the second shaft 605 via the third spur gear 600. Because the third spur gear 600 is approximately the same size as the second spur gear 580, there is no second stage reduction and the second shaft 605 rotates at a fourth speed that is the same as the second speed. Thus, for a given transmission output speed, the second shaft 605 rotates about 2.5 times faster when the control system 30 is in the first position than it does when the control system 30 is in the second or third positions.

The fifth spur gear 615 engages the ring gear 620 to rotate the ring gear 620 at a fifth speed. The ring gear is approximately 3 times the size of the fifth spur gear 615. As such, the fifth speed is approximately one-third the third speed when the control system 30 is in the second and third positions and one-third the fourth speed when the control system 30 is in the first position.

The illustrated construction provides a speed reduction of between about 18 to 1 and 19 to 1 when the control system 30 is in the second position or the third position, and a speed reduction of about 7.5 to 1 when the control system 30 is in the first position. Thus, when the input pulley 90 rotates at 2000 rpm, the ring gear 620 rotates at about 110 RPM when the control system 30 is in the second position or the third position, and about 265 RPM when the control system 30 is in the first position. In addition to the reduction in speed, there is a corresponding increase in torque at the ring gear 620.

During straight-line operation of the vehicle 10, rotation of the ring gear 620 produces a corresponding rotation of the ring bevel gears 650. However, the ring bevel gears 650 do not rotate about the ring gear shafts 645. As such, the ring bevel gears 650 couple the axle bevel gears 665 to the ring gear 620 such that the axle bevel gears 665 rotate at substantially the same speed as the ring gear 620. In addition, the axles 625 and the wheels 655 attached to the axles 625 rotate at substantially the same speed as the ring gear 620.

During a turn, one of the wheels 655, axles 625, and axle bevel gears 665 must rotate slightly slower than the opposite wheel 655, axle 625, and axle bevel gear 665. To facilitate this, the ring bevel gears 650 rotate about the ring shaft axes. The rotation of the ring bevel gears 650 allows one axle bevel gear 665 to rotate slower than the ring gear 620, while simultaneously allowing the opposite axle bevel gear 665 to rotate faster.

While the illustrated construction includes spur gears and bevel gears, one of ordinary skill in the art will realize that other types of gears (e.g., helical, etc.) could be employed. Furthermore, additional components not described herein may also be included in the transmission 20, differential 25, or control system 30.

The illustrated construction provides a continuously variable drive train that is operable across a large speed range. Some of the speed variation is provided by the transmission module 20 and some is provided by the differential module 25. For example, the transmission module 20 may allow for a variation of speed across a first speed range. The differential module 25 steps the first speed range down and provides for forward operation in a first, or low speed range and a second, or high speed range. Generally, the speed ranges overlap slightly. However, if properly arranged, the low and high speed ranges can cooperate to provide nearly double the speed range provided by the transmission alone. In addition, the differential module 25 allows for efficient variable speed operation in reverse. All of the speed and direction changes can be made using a single simple user interface 370 without a clutch. This greatly simplifies operation of the tractor 10 and reduces the number of components required to assemble the control system 30.

Various features and advantages of the invention are set forth in the following claims.

What is claimed is:

1. A drive train for use with a tractor having an engine, the drive train comprising:
a transmission module including an input side coupled to the engine and an output side, the output side rotatable in response to rotation of the input side to define a transmission speed ratio;
a differential module including a drive input coupled to the output side, and including an axle, the axle being configured to rotate in response to rotation of the drive input to define a differential speed ratio; and
a control module coupled to the transmission module and to the differential module, and configured to independently vary the transmission speed ratio and the differential speed ratio.

2. The drive train of claim 1, wherein the transmission module includes a continuously variable transmission.

3. The drive train of claim 1, wherein the input side includes a pulley having a fixed portion and a movable portion, the control system being configured to move the movable portion with respect to the fixed portion.

4. The drive train of claim 3, wherein the output side includes a second pulley having a second fixed portion and a second movable portion.

5. The drive train of claim 1, wherein the transmission module includes a primary belt that couples the input side to the output side for rotation, and wherein the second movable portion is configured to move in response to a belt tension.

6. The drive train of claim 1, wherein the control system includes an operator link that is configured to move in a first direction to vary the transmission speed ratio, and to move in a second direction to vary the differential speed ratio.

7. The drive train of claim 6, wherein the differential is configurable into a high-speed arrangement, a low speed arrangement, and a reverse arrangement, and wherein movement of the operator link in the second direction configures the differential module into one of the high-speed arrangement, the low speed arrangement, and the reverse arrangement.

8. The drive train of claim 6, wherein the second direction is substantially normal to the first direction.

9. A drive train for use with a tractor, the drive train comprising:
an engine;
a transmission module including an input side and an output side, the input side coupled to the engine such that the input side rotates at a first speed, the output side operatively connected to the input side and configured to rotate at a second speed;
a differential module including a differential input and an axle, the differential input operatively coupled to the output side and configured to rotate at a third speed in response to rotation of the output side, the axle configured to rotate at a fourth speed in response to rotation of the differential input; and
a control module coupled to the transmission module and the differential module and configured to vary a first ratio of the first speed to the second speed, and configured to vary a second ratio of the third speed to the fourth speed.

10. The drive train of claim 9, wherein the transmission module includes a continuously variable transmission.

11. The drive train of claim 9, wherein the input side includes a pulley having a fixed portion and a movable portion, the control system configured to move the movable portion with respect to the fixed portion.

12. The drive train of claim 11, wherein the output side includes a second pulley having a second fixed portion and a second movable portion.

13. The drive train of claim 9, wherein the transmission module includes a primary belt that couples the input side to the output side for rotation, and wherein the second movable portion is configured to move in response to a belt tension.

14. The drive train of claim 9, wherein the control system includes an operator link that is configured to move in a first direction to vary the first ratio, and in a second direction to vary the second ratio.

15. The drive train of claim 14, wherein the differential is configurable into a high-speed arrangement, a low speed arrangement, and a reverse arrangement, and wherein movement of the operator link in the second direction configures the differential module into one of the high-speed arrangement, the low speed arrangement, and the reverse arrangement.

16. The drive train of claim 14, wherein the second direction is substantially normal to the first direction.

17. A drive train for use with a tractor having an engine, the drive train comprising:
a transmission module including an input side coupled to the engine, and including an output side, the output side rotatable in response to rotation of the input side to define a transmission speed ratio;
a differential module including a drive input coupled to the output side, and including an axle, the axle rotatable in response to rotation of the drive input to define a differential speed ratio and a speed direction; and
a control module coupled to the transmission module and the differential module, the control module including an operator interface configured to move in a first direction to vary the transmission speed ratio, and configured to move in a second direction to vary both the differential speed ratio and the speed direction.

18. The drive train of claim 17, wherein the transmission module includes a continuously variable transmission.

19. The drive train of claim 17, wherein the input side includes a pulley having a fixed portion and a movable portion, the control system configured to move the movable portion with respect to the fixed portion.

20. The drive train of claim 19, wherein the output side includes a second pulley having a second fixed portion and a second movable portion.

21. The drive train of claim 17, wherein the transmission module includes a primary belt that couples the input side to the output side for rotation, and wherein the second movable portion is configured to move in response to a belt tension.

22. The drive train of claim 17, wherein the differential is configurable into a high-speed arrangement, a low speed arrangement, and a reverse arrangement, and wherein movement of the operator link in the second direction configures the differential module into one of the high-speed arrangement, the low speed arrangement, and the reverse arrangement.

23. The drive train of claim 17, wherein the second direction is substantially normal to the first direction.
